(19) United States
(12) Patent Application Publication
(10) Pub. No.: US 2009/0035158 A1
(43) Pub. Date: Feb. 5, 2009

(54) COOLING FAN

(75) Inventors: WUN-CHANG SHIH, Tu-Cheng (TW); QIANG ZHANG, Shenzhen (CN); RUI-JUN HUANG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 11/873,244

(22) Filed: Oct. 16, 2007

(30) Foreign Application Priority Data
Aug. 3, 2007 (CN) 200710075610.8

(51) Int. Cl. F04B 17/03; F16C 17/02; F16C 33/02; H02K 5/16; H02K 7/08

(52) U.S. Cl. 417/354; 310/90; 384/279

(57) ABSTRACT

A cooling fan includes a fan housing (10) having a central tube (18) extending upwardly therein. A sleeve bearing (40) is received in the central tube. A stator (20) is mounted around the central tube. A rotor (30) has a shaft (36) being rotatably received in the sleeve bearing. The sleeve bearing defines a bearing hole (42) therethrough. The bearing hole (42) receives the shaft of the rotor to rotate therein. A plurality of irregular pores and at least one blind hole (44) are defined in the sleeve bearing and impregnated with lubricant oil.

### BACKGROUND OF THE INVENTION

1. Field of the Invention

The present invention relates to a cooling fan, and more particularly to a sleeve bearing of a cooling fan which has good lubricating characteristics.

2. Description of Related Art

With the continuing development of the electronic technology, electronic packages such as CPUs (central processing units) are generating more and more heat that requires immediate dissipation. Cooling fans are commonly used in combination with heat sinks for cooling the CPUs. Cooling fan performance mostly depends on performance characteristics of a bearing used thereby. Good lubrication of the bearing increases the life-span of the bearing.

A conventional cooling fan includes a rotor having a stainless shaft extending downwardly from a central portion thereof, a sleeve bearing defining an inner hole receiving the shaft therein, and a frame forming a central tube at a middle portion thereof receiving the bearing therein. The bearing is made of sintered metal powders and has a plurality of irregular pores which are connected together in a labyrinth-like manner and impregnated with lubricant oil. Since a porosity of the bearing is limited by the sintering process, the lubricant oil impregnated in the bearing is limited. During operation of the cooling fan, the lubricant oil of the bearing creeps up along the rotating shaft under the influence of the centrifugal force generated by the rotary shaft and is lost; the lubricant oil of the bearing is thus gradually diminished. Thus after rotating for a period of time, the rotary shaft and the bearing will experience wear due to the leak of the lubricant oil contained therebetween. As a result, the performance of the cooling fan is deteriorated, and the life-span thereof is shortened.

Therefore, it is desirable to provide a cooling fan wherein one or more of the foregoing disadvantages may be overcome or at least alleviated.

### SUMMARY OF THE INVENTION

According to a preferred embodiment of the present invention, a cooling fan includes a fan housing having a central tube extending upwardly therein; a sleeve bearing is received in the central tube; a stator is mounted around the central tube; and a rotor has a shaft being rotatably received in the sleeve bearing. The sleeve bearing defines a bearing hole therethrough, a plurality of irregular pores which are connected together in a labyrinth-like arrangement and at least one blind hole being defined in the sleeve bearing. The bearing hole receives the shaft therein. The pores and the blind hole are impregnated with lubricant oil.

Other advantages and novel features of the present invention will become more apparent from the following detailed description of preferred embodiment when taken in conjunction with the accompanying drawings, in which:

### BRIEF DESCRIPTION OF THE DRAWINGS

Many aspects of the present cooling fan can be better understood with reference to the following drawings. The components in the drawings are not necessarily drawn to scale, the emphasis instead being placed upon clearly illustrating the principles of the present cooling fan. Moreover, in the drawings, like reference numerals designate corresponding parts throughout the several views.

FIG. 1 is an isometric, assembled view of a cooling fan according to a preferred embodiment of the present invention;

FIG. 2 is an explored view of the cooling fan in FIG. 1;

FIG. 3 is a cross sectional view of the cooling fan taken along line III-III of FIG. 1; and

FIG. 4 is an isometric, enlarged view of a bearing of the cooling fan of FIG. 1.

### DETAILED DESCRIPTION OF THE INVENTION

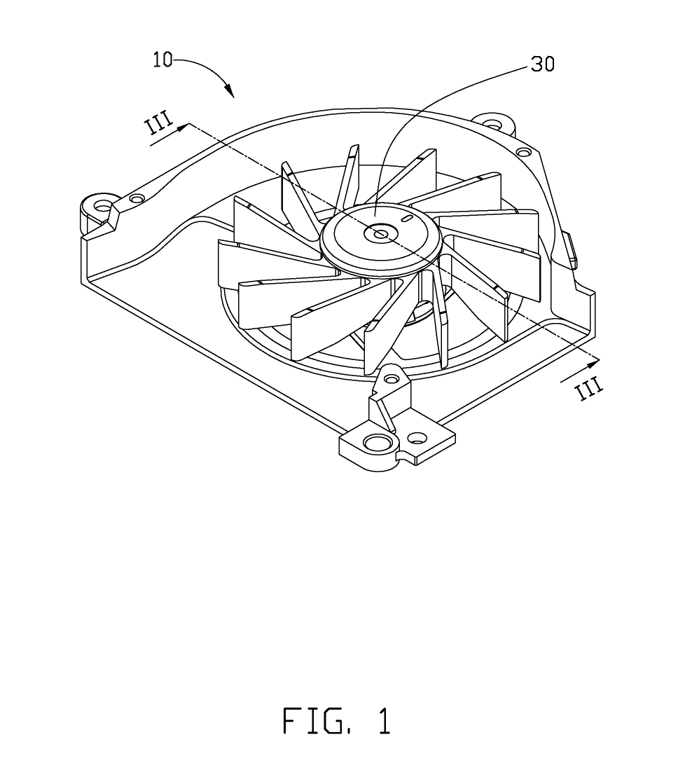

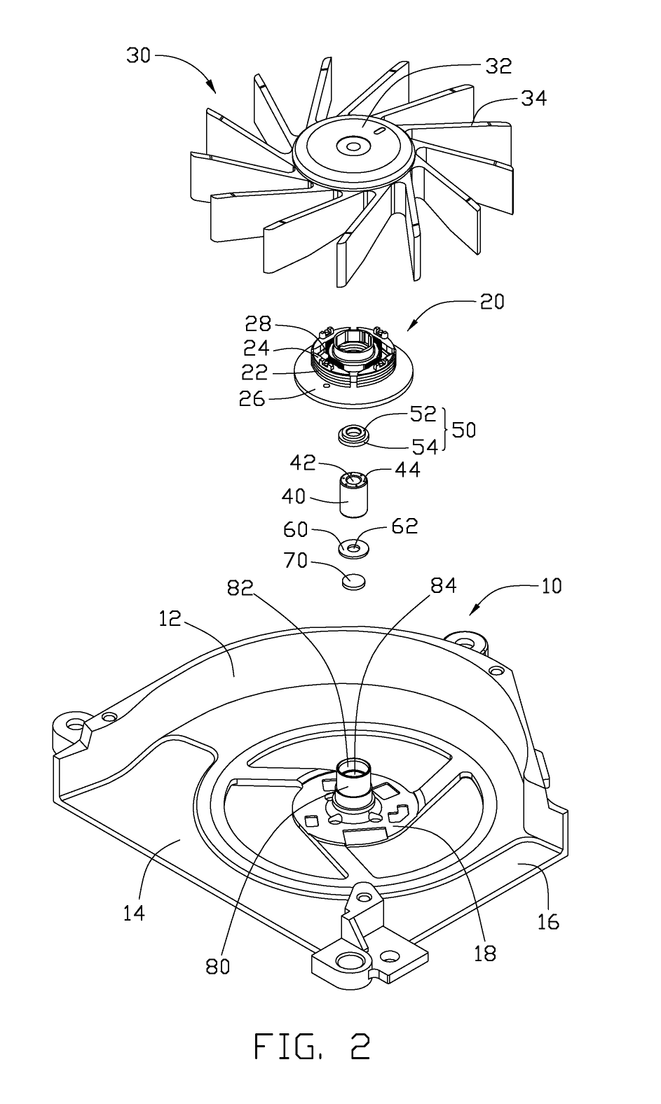

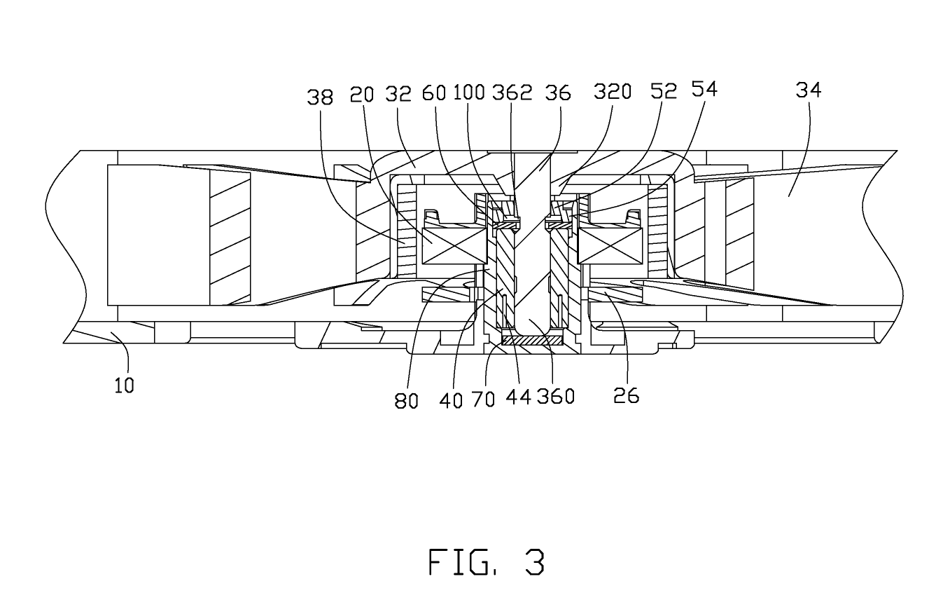

Referring to FIGS. 1 through 3, a cooling fan according to a preferred embodiment includes a fan housing 10, a sleeve bearing 40, a rotor 30, and a stator 20 in respective to which the rotor 30 is rotatable. In this embodiment, the cooling fan is a blower, which has an air inlet 12 formed in a top thereof, and a pair of air outlets 14, 16 being perpendicular to the air inlet 12. The air outlets 14, 16 are oriented perpendicular to each other.

The fan housing 10 includes a base 18 and a central tube 80 extending upwardly from a central portion of the base 18. The central tube 80 defines a central hole 84 therein and forms an open end at a top portion thereof. An annular end opening 82 is formed on an inner circumference of the top portion of the central tube 80. The end opening 82 communicates with the central hole 84. Thus the top portion of the central tube 80 has an inner diameter larger than that of the other portion of the central tube 80. A bottom end of the central tube 80 is closed. A counter plate 70 made of high abrasion-resistant material is arranged in the bottom end of the central tube 80.

The stator 20 is mounted around the central tube 80. The stator 20 includes a stator core 22 with stator coils 24 wound thereon to establish an alternating magnetic field, and a PCB 26 (printed circuit board) being electrically connected with the stator coils 24 of the stator core 22. The PCB 26 has an inner diameter approximately the same as an outer diameter of the central tube 80, and is fixed to an outer surface of the central tube 80. To avoid the coils from coming into electrical contact with the stator core 22, upper and lower insulating frames 28 are used to cover the stator core 22 and electrically insulate the stator coils 24 from the stator core 22.

The rotor 30 includes a hub 32 forming a shaft seat 320 at a central portion thereof, a plurality of fan blades 34 extending radially from an outer periphery of the hub 32, a magnet 38 adhered to an inner side of the hub 32, and a shaft 36 received in the shaft seat 320 and extending downwardly from a central portion of the shaft seat 320. The shaft 36 defines an annular slot 362 in an outer surface thereof, near a top end adjacent to the hub 32.

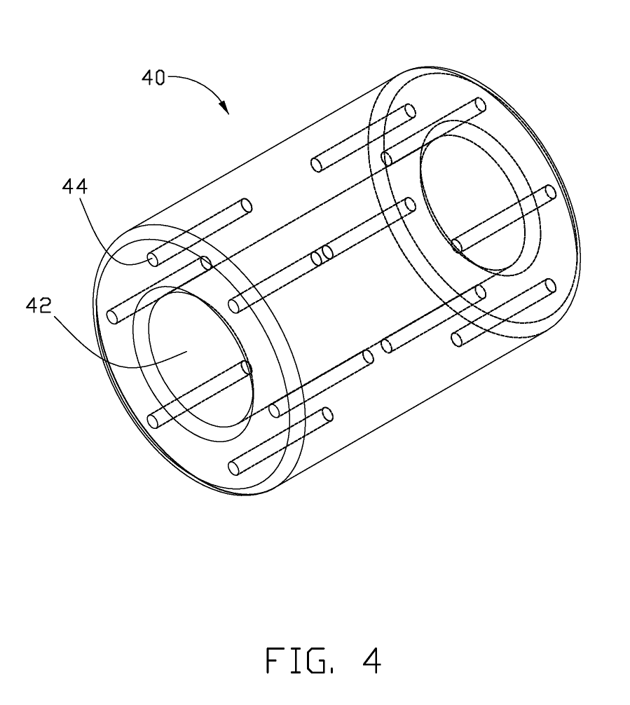

Referring to FIG. 4, the sleeve bearing 40 is received in the central hole 84 of the central tube 80. The sleeve bearing 40 defines a bearing hole 42 for the shaft 36 of the rotor 30 extending therethrough. The sleeve bearing 40 is formed by sintering metal powder, and thus a plurality of irregular pores (not shown) are defined in the sleeve bearing 40. The pores communicate with each other in a labyrinth-like manner and are impregnated with lubricant oil for self-lubrication. A plurality of blind holes 44 are defined in the sleeve bearing 40. The blind holes 44 are formed during the sintering process for making the sleeve bearing 40, and also are impregnated with the lubricant oil. The blind holes 44 are arranged at two ends (top and bottom ends) of the sleeve bearing 40. Each of the blind holes 44 extends from a surface into the sleeve bearing 40. In this embodiment, the blind boles 44 extend inwardly from a top end surface and a bottom end surface of the sleeve bearing 40 along an axial direction thereof. Alternatively, the blind holes 44 may extend along a radial direction of the sleeve bearing 40, and in this situation, the blind holes 44 can extend inwardly from an outer surface of the sleeve bearing 40 or extend outwardly from an inner surface of the sleeve bearing 40. Also the blind holes 44 can extend aslant or be curved.

Each end of the sleeve bearing 40 has six blind holes 44, which are arranged evenly spaced from each other along a circumferential direction of the sleeve bearing 40. All of the blind holes 44 are arranged at a middle of the sleeve bearing 40 along the radial direction of the sleeve bearing 40. In other words, the blind holes 44 are arranged at a middle of the outer surface and the inner surface of the sleeve bearing 40. The blind holes 44 of the two ends of the sleeve bearing 40 are alternately arranged along the circumferential direction of the sleeve bearing 40. Each blind hole 44 has a height of about 1.8 mm along the axial direction, which is about ⅓ of the height of the sleeve bearing 40. Alternatively, the height of the blind holes 44 can be changed according to the height of the sleeve bearing 40, preferably not larger than a half of the height of the sleeve bearing 40. A diameter of each blind hole 44 is about 0.2 mm. The diameter of each of the blind holes 44 is designed to hold the lubricant oil therein when the rotor 30 is static. The number and the position of the blind holes 44 can be changed according to the size of the sleeve bearing 40, provided that the sleeve bearing 40 is strong enough to support the rotor 30.

When assembled, the stator 20 is mounted around the central tube 80. The sleeve bearing 40 is received in the central tube 80. The top end of the sleeve bearing 40 is lower than the top end of the central tube 80. An oil-retaining cover 50 is mounted in the end opening 82 of the central tube 80. The cover 50 has an upper portion 52 with an inner diameter approximately the same as a diameter of the shaft 36, and a lower portion 54 with an inner diameter larger than the diameter of the shaft 36. The shaft 36 of the rotor 30 extends through the oil-retaining cover 50 and then the bearing hole 42 of the sleeve bearing 40 into the central hole 84 of the central tube 80; thus, the shaft 36 rotatably engages with the sleeve bearing 40. The magnet 38 of the rotor 30 is located around the stator 20 and faces the stator core 22 of the stator 20. An oil buffer 100 is thus formed among the central tube 80, the shaft 36, the top end of the sleeve bearing 40 and the oil-retaining cover 50 for receiving lubricant oil therein. The slot 362 of the shaft 36 is located between the oil-retaining cover 50 and the top end of the sleeve bearing 40, and thus communicates with the oil buffer 100. A locking washer 60 is received in the end opening 82 of the central tube 80 and is arranged between the cover 50 and the sleeve bearing 40. The locking washer 60 defines an inner hole 62 with a diameter smaller than that of the shaft 36, but larger than that of the portion of the shaft 36 defining the slot 362. Thus the locking washer 60 is engaged in the slot 362 of the shaft 36 to limit movement of the shaft 36 along an axial direction thereof. The counter plate 70 faces and supportively engages a bottom end 360 of the shaft 36.

During operation, the rotor 30 is driven to rotate by the interaction of the alternating magnetic field established by the stator 20 and the magnetic field of the rotor 30. When lubricant oil creeps up along the rotating shaft 36 under the influence of the centrifugal force generated by the rotation of the shaft 36, the oil-retaining cover 50 can sufficiently prevent the oil from leaking out of the sleeve bearing 40. Thus the escaping lubricant oil is received in the oil buffer 100 and then flows back to the bearing hole 42 of the sleeve bearing 40. Therefore the lubricant oil can be kept from leaking out of the sleeve bearing 40. On the other hand, even if a spot of lubricant oil indeed leaves the sleeve bearing 40, due to the blind holes 44 defined in the sleeve bearing 40, the amount of lubricant oil impregnated in the sleeve bearing 40 is significantly increased in comparison with the conventional sleeve bearing; thus, there is still enough amount of lubricant oil in the sleeve bearing 40 in accordance with the present invention to lubricate the sleeve bearing 40 and the rotary shaft 36; thus, good lubrication of the rotary shaft 36 and the sleeve bearing 40 of the present invention is constantly maintained, thereby improving the quality and life-span of the cooling fan.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cooling fan comprising:
a fan housing having a central tube extending upwardly therein;
a sleeve bearing received in the central tube, the sleeve bearing defining a bearing hole therethrough, a plurality of irregular pores connected together and at least one blind hole being defined in the sleeve bearing, the pores and the blind hole being impregnated with lubricant oil;
a stator being mounted around the central tube; and
a rotor having a shaft being rotatably received in the bearing hole of the sleeve bearing.

2. The cooling fan of claim 1, wherein the at least one blind hole extends from a surface into the sleeve bearing along one of an axial direction and a radial direction of the sleeve bearing.

3. The cooling fan of claim 1, wherein the at least one blind hole comprises a plurality of blind holes formed on two opposite ends of the sleeve bearing, and the blind holes extend inwardly from two opposite end surfaces of the sleeve bearing.

4. The cooling fan of claim 3, wherein the blind holes of each end of the sleeve bearing are evenly spaced from each other along a circumferential direction of the sleeve bearing.

5. The cooling fan of claim 3, wherein the blind holes of the two ends of the sleeve bearing are alternately arranged along the circumferential direction of the sleeve bearing.

6. The cooling fan of claim 3, wherein the blind holes are arranged at a middle of an inner surface and an outer surface along the radial direction of the sleeve bearing.

7. The cooling fan of claim 3, wherein the blind holes each have a height not larger than a half of that of the sleeve bearing.

8. The cooling fan of claim 1, wherein the at least one blind hole has a diameter not larger than 0.2 mm.

9. The cooling fan of claim 1, wherein the sleeve bearing is located below a top end of the central tube, an oil-retaining cover being mounted around the shaft and received in the top end of the central tube, the oil-retaining cover comprising an upper portion with an inner diameter being approximately the same as a diameter of the shaft, and a lower portion with an inner diameter larger than the diameter of the shaft and an outer diameter being approximately the same as an inner diameter of the top end of the central tube, an oil buffer being formed among the shaft, the sleeve bearing, the oil-retaining cover and the central tube.

10. A sleeve bearing comprising a bearing hole extending therethrough, a plurality of pores being defined in the bearing, connected together in a labyrinth-like manner and impregnated with lubricant oil, and at least one blind hole being defined in the sleeve bearing and impregnated with the lubricant oil thereby for increasing an amount of the lubricant oil receivable by the sleeve bearing.

11. The sleeve bearing of claim 10, wherein the at least one blind hole comprises a plurality of blind holes formed on two opposite ends of the sleeve bearing, and the blind holes extend inwardly from two opposite end surfaces of the sleeve bearing.

12. The sleeve bearing of claim 11, wherein the blind holes of each end of the sleeve bearing are evenly spaced from each other along a circumferential direction of the sleeve bearing, and the blind holes of the two ends of the sleeve bearing are alternately arranged along the circumferential direction of the sleeve bearing.

13. The sleeve bearing of claim 11, wherein the blind holes are arranged at a middle of an inner surface and an outer surface of the bearing along a radial direction.

14. The sleeve bearing of claim 11, wherein the blind holes each have a height not larger than a half of that of the sleeve bearing.

15. The sleeve bearing of claim 10, wherein the at least one blind hole has a diameter not larger than 0.2 mm.

16. A sleeve bearing comprising:
a sleeve made of sintered metal powder;
a bearing hole defined through the sleeve, adapted for receiving a shaft therein;
a plurality of irregular pores defined in the sleeve; and
a plurality of round blind holes defined in the sleeve;
wherein the pores and the blind holes are filled with lubricant oil.

17. The sleeve bearing of claim 16, wherein the blind holes extend inwardly from two opposite outer ends of the sleeve.

18. The sleeve bearing of claim 17, wherein the blind holes of the two opposite outer ends of the sleeve are alternate with each other along a circumferential direction of the sleeve.

19. The sleeve bearing of claim 17, wherein each of the blind holes has a depth which is about ⅓ of a length of the sleeve.
